(19) United States
(12) Patent Application Publication
(10) Pub. No.: US 2023/0261270 A1
(43) Pub. Date: Aug. 17, 2023

(54) BATTERY CHARGING AND DISCHARGING JIG WITH MULTIPLE POWER CONNECTIONS AND BATTERY CHARGING AND DISCHARGING SYSTEM COMPRISING THE SAME

(71) Applicant: LG ENERGY SOLUTION, LTD., Seoul (KR)

(72) Inventor: Ji Sun LEE, Daejeon (KR)

(73) Assignee: LG ENERGY SOLUTION, LTD., Seoul (KR)

(21) Appl. No.: 18/125,511

(22) Filed: Mar. 23, 2023

Related U.S. Application Data
(63) Continuation of application No. PCT/KR2021/012943, filed on Sep. 23, 2021.

(30) Foreign Application Priority Data
Sep. 24, 2020 (KR) 10-2020-0124181

(51) Int. Cl. H01M 10/44; H02J 7/00; H02J 7/04; H01M 50/543; H01M 50/533; H01M 10/48; H01M 10/42

(52) U.S. Cl. CPC H01M 10/441; H02J 7/0042; H02J 7/04; H01M 50/543; H01M 50/533; H01M 10/486; H01M 10/425

(57) ABSTRACT

A jig for charging and discharging a battery cell and a system for charging and discharging a battery cell including the jig is provided. The jig includes a fixing unit which fixes a battery cell, first and second terminal portions which are electrically connected to first and second electrode leads of the fixed battery cell, respectively, and a socket fastening unit which has a first end fastened to the first terminal portion or the second terminal portion, and a second end having two or more connection sockets to be electrically connected to an external side.

### CROSS-REFERENCE TO RELATED APPLICATIONS

This application is a Continuation of PCT International Application No. PCT/KR2021/012943, filed on Sep. 23, 2021, which claims the benefit of priority based on Korean Patent Application No. 10-2020-0124181, filed on Sep. 24, 2020, all of which are hereby expressly incorporated by reference into the present application.

### TECHNICAL FIELD

The present invention provides a jig for charging and discharging a battery cell to which a new power supply scheme has been applied, and a system for charging and discharging a battery cell including the jig.

### BACKGROUND ART

In recent years, as the price of energy sources increases due to the depletion of fossil fuels and the interest of environmental pollution is amplified, the demand for environmentally friendly alternative energy sources has become an indispensable factor for future life. As such, various researches on power generation technologies such as nuclear power, solar power, wind power, and tidal power have been continued, and electric power storage devices for more efficient use of such generated energy have also been attracting much attention.

In particular, with the development of technology and demand for mobile devices, the demand for batteries as energy sources is rapidly increasing, and accordingly, a lot of researches on batteries capable of meeting various demands have been conducted.

Typically, in terms of the shape of the battery, there is a high demand for a prismatic secondary battery and a pouch-type secondary battery that can be applied to products such as mobile phones with a small thickness. In terms of materials, there is a high demand for lithium secondary batteries such as lithium ion batteries and lithium ion polymer batteries having advantages such as high energy density, discharge voltage, and output stability.

A secondary battery is manufactured by accommodating an electrode assembly in a battery case and injecting electrolyte, followed by a battery activation step. At this time, the battery activation step includes the process of charging and discharging the secondary battery in the conditions necessary for activation after mounting the secondary battery in a cell jig. Such a cell jig is mainly used to charge or discharge the secondary battery in the battery activation step, as well as used for performance evaluation purposes of the secondary battery.

FIG. 1 is a photograph showing a power terminal which connects an external power source to a conventional battery cell charge and discharge jig, and FIG. 2 is a schematic diagram showing a structure of fastening a power terminal which connects an external power source to a socket fastening unit in a conventional battery cell charge and discharge jig. Referring to FIGS. 1 and 2, a conventional battery cell charge and discharge jig 10 includes a battery cell 20 fixed at the jig 10 and first and second terminal portions 21 and 22 electrically connected to first and second electrode leads of the battery cell 20. Further, the first and second terminal portions 21 and 22 are electrically connected to a power supply unit. Specifically, a first power terminal 11 of the power supply unit is connected to the first terminal portion 21 of the jig 10, and a second power terminal 12 of the power supply unit is connected to the second terminal portion 22 of the jig 10. In this case, the power supply unit is electrically connected to one jig 10. Further, if the standard of the battery cell 20 housed in the jig 10 is changed, there is a problem that the power supply unit should be replaced.

Hence, there is a need for a new charge and discharge technology that can efficiently charge and discharge battery cells 20 without replacement of a power supply unit even in the case that the standard of the battery cell 20 is changed or a plurality of battery cells 20 should be simultaneously charged and discharged.

### DISCLOSURE

### Technical Problem

In order to solve the above problems of the prior art, the present invention provides a jig for charging and discharging a battery cell to which a new power supply scheme has been applied, and a system for charging and discharging a battery cell including the jig.

### Technical Solution

The present invention relates to a jig for charging and discharging a battery cell. In one example, a jig for charging and discharging a battery cell includes: a fixing unit to fix a battery cell; first and second terminal portions electrically connectable to first and second electrode leads of the fixed battery cell, respectively; and a socket fastening unit having a first end fastened to the first terminal portion or the second terminal portion, and a second end having two or more connection sockets to be electrically connected to an external side.

In one example, at least one of the two or more connection sockets is a socket for serial connection and at least one other of the two or more connection sockets is a socket for parallel connection.

In a specific example, the at least one of the two or more connection sockets for serial connection is electrically connectable to another battery cell in series or is electrically connected to a power supply unit, and the at least one other of the two or more connection sockets for parallel connection is electrically connectable to another battery cell in parallel.

In another specific example, the socket fastening unit includes a number of p sockets for serial connection and a number of q sockets for parallel connection as the two or more connection sockets. Herein, the p is a positive integer between 1 and 20, and the q is a positive integer between 1 and 20.

In another example, the first end of the socket fastening unit is fastenable to the first terminal portion of the battery cell fixed at the fixing unit. Further, the two or more connection sockets at the second end of the socket fastening unit include one or more sockets for serial connection and one or more sockets for parallel connection, which satisfy at least one of:

(1) a condition that at least one of the sockets for serial connection is electrically connected to a power supply unit;

(2) a condition that at least one of the sockets for serial connection is electrically connected to a second terminal portion of another battery cell adjacent to the battery cell; and

(3) a condition that at least one of the sockets for parallel connection is electrically connected to a first terminal portion of another battery cell adjacent to the battery cell.

In one example, at least one electrical connection pin is provided at the first end of the socket fastening unit, and at least one groove for accommodating the electrical connection pin is formed at the second end of the socket fastening unit.

In a specific example, the fixing unit is configured to press two surfaces of the battery cell through a pressing plate, and the first and second terminal portions are electrically connectable to the first and second electrode leads, respectively, in a state that the first and second electrode leads of the battery cell are fixed.

In another specific example, the fixing unit is configure to press two surfaces of the battery cell through a pressing plate, and further includes at least one of: a pressure sensor to measure pressure of the battery cell; or a temperature sensor to measure a temperature of the battery cell.

Further, the present invention provides a system for charging and discharging a battery cell, which includes the above-described jig for charging and discharging a battery cell. In one example, the system includes: a number of n jigs for charging and discharging a battery cell; and a power supply unit. Herein, the n is a positive integer equal to or greater than 2.

In one example, the number of n jigs are arranged in series or in parallel in a state that has accommodated battery cells.

In a specific example, the power supply unit is a single power source, and the number of n jigs are electrically connected to each other in at least one of a serial connection scheme and a parallel connection scheme in a state that has accommodated battery cells.

In another specific example, a power connection line, which is fastened to one of the two or more connection sockets of the socket fastening unit of each jig, is switched to satisfy a rated voltage condition of the battery cell.

### Advantageous Effects

A jig for charging and discharging a battery cell according to the present invention, and a system for charging and discharging a battery cell including the jig allow battery cell of various standards to be charged and discharged by changing electric connection schemes according to the rated voltage of the battery cell.

### BRIEF DESCRIPTION OF THE DRAWINGS

FIG. 1 is a photograph showing a power terminal which connects an external power source to a conventional battery cell charge and discharge jig.

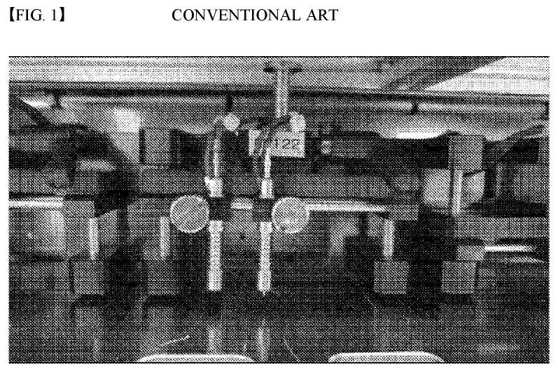

FIG. 2 is a schematic diagram showing a structure of fastening a power terminal which connects an external power source to a socket fastening unit in a conventional battery cell charge and discharge jig.

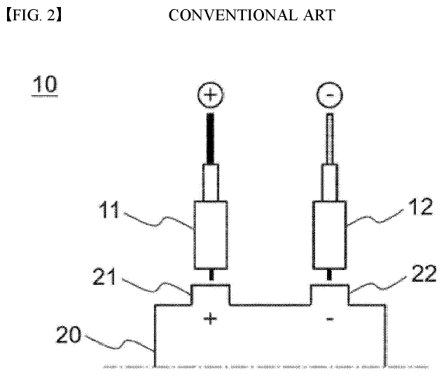

FIG. 3 is a schematic diagram showing a structure of fastening a power terminal which connects an external power source to a socket fastening unit in a battery cell charge and discharge jig according to one embodiment of the present invention.

FIG. 4 is a plan view showing a socket fastening unit in a battery cell charge and discharge jig according to one embodiment of the present invention.

FIG. 5 is a schematic diagram showing an exemplary electric connection between single power supply and a plurality of battery cells using a connection socket.

FIG. 6 is a schematic diagram showing an exemplary electric connection between single power supply and a plurality of battery cell charge and discharge jigs.

### DETAILED DESCRIPTION OF THE PREFERRED EMBODIMENTS

As the inventive concept allows for various changes and numerous embodiments, particular embodiments will be illustrated in the drawings and described in detail in the text. However, this is not intended to limit the present invention to the specific form disclosed, and it should be understood to include all changes, equivalents, and substitutes included in the spirit and scope of the present invention.

In this application, it should be understood that terms such as “include” or “have” are intended to indicate that there is a feature, number, step, operation, component, part, or a combination thereof described on the specification, and they do not exclude in advance the possibility of the presence or addition of one or more other features or numbers, steps, operations, components, parts or combinations thereof. Also, when a portion such as a layer, a film, an area, a plate, etc. is referred to as being “on” another portion, this includes not only the case where the portion is “directly on” the another portion but also the case where further another portion is interposed therebetween. On the other hand, when a portion such as a layer, a film, an area, a plate, etc. is referred to as being “under” another portion, this includes not only the case where the portion is “directly under” the another portion but also the case where further another portion is interposed therebetween. In addition, to be disposed “on” in the present application may include the case disposed at the bottom as well as the top.

The present invention provides a jig for charging and discharging a battery cell. In one example, a jig for charging and discharging a battery cell includes: a fixing unit which fixes a battery cell; first and second terminal portions which are electrically connected to first and second electrode leads of the fixed battery cell, respectively; and a socket fastening unit which has one end fastened to the first terminal portion or the second terminal portion, and the other end having two or more connection sockets to be electrically connected to an external side.

The jig for charging and discharging a battery cell according to the present invention includes a socket fastening unit for connecting the jig to an external power source, and the socket fastening unit may implement various electric connections. For example, the socket fastening unit has a structure in which a plurality of connection lines can be fastened in a multi-tap scheme. As such, even if the battery cell standard is changed, the battery cell charge and discharge jig according to the present invention can derive charge and discharge conditions which satisfy the changed battery cell standard. In some cases, the battery cell charge and discharge jig can simultaneously charge and discharge battery cells of different standards.

In one embodiment, the socket fastening unit has a plurality of connection sockets. Specifically, at least one of the connection sockets is a socket for serial connection and at least one of the connection sockets is a socket for parallel connection. For example, the socket for serial connection is electrically connected to another battery cell in series or is electrically connected to a power supply unit, and the socket for parallel connection is electrically connected to another battery cell in parallel. The socket for serial connection may be electrically connected to another battery cell in series and may be electrically connected to the power supply unit if necessary. Further, the socket for parallel connection may be electrically connected to another battery cell in parallel. It may be changed according to the standard of the battery cell, but for example, when the voltage applied to the power supply unit is the same as the charge and discharge voltage of the battery cell, direct electric connection is made with the power supply unit through the socket for serial connection. Further, electric serial connection is made with the terminal portion of another adjacent jig so that the same voltage may be applied to the battery cell accommodated in an adjacent jig. In another example, when the voltage applied to the power supply unit is different from the charge and discharge voltage of the battery cell, electric connection is made with the power supply unit through the socket for parallel connection, and electric parallel connection is made with the terminal portion of another adjacent jig. Through this, the charge and discharge voltage required in the battery cell is made to fit the voltage applied from the power supply unit.

In a specific example, in the jig for charging and discharging a battery cell according to the present invention, the socket fastening unit includes a number of p sockets for serial connection and a number of q sockets for parallel connection as the connection sockets. Herein, the p is a positive integer between 1 and 20, and the q is a positive integer between 1 and 20. Specifically, the connection sockets of the socket fastening unit include 1 to 5 sockets for serial connection and 1 to 5 sockets for parallel connection. More specifically, the connection sockets of the socket fastening unit include 2 sockets for serial connection and 2 sockets for parallel connection. For example, the socket fastening unit includes 4 connection sockets which are arranged in a 2×2 form. 2 connection sockets at the upper end of the socket fastening unit are sockets for serial connection, and 2 connection sockets at the lower end of the socket fastening unit are sockets for parallel connection. Through this, a plurality of jigs are electrically connected in series/in parallel so that the charge and discharge standard of the battery cell correspond to the voltage applied from the power supply unit.

In one embodiment, in a jig for charging and discharging a battery cell according to the present invention, the one end of the socket fastening unit is fastened to the first terminal portion of the battery cell fixed at the fixing unit, and connection sockets formed at the other end of the socket fastening unit include one or more sockets for serial connection and one or more sockets for parallel connection, which satisfy at least one of: (1) a condition that at least one of the sockets for serial connection is electrically connected to a power supply unit; (2) a condition that at least one of the sockets for serial connection is electrically connected to a second terminal portion of another battery cell adjacent to the battery cell; and (3) a condition that at least one of the sockets for parallel connection is electrically connected to a first terminal portion of another battery cell adjacent to the battery cell.

For example, the power applied from the power supply unit is 9V, the charge and discharge standard of the battery cell is 4.5V, and 48 battery cells are simultaneously charged and discharged. In this case, the first connection socket is fastened to (+) terminal of the power supply unit. At this time, the second connection socket of the first jig is electrically connected to the second jig in series. Through this, 4.5V voltage is applied to the battery cell of the first jig and the second jig, respectively. The third connection socket of the first jig is electrically connected to other 24 jigs in parallel, and are sequentially, electrically connected to further other 24 jigs through the second jig connection sockets. Further, one of the second jig connection sockets is fastened to (−) terminal of the power supply unit. Through this process, 4.5V power is applied to all of 48 battery cells.

Specifically, in a system in which a plurality of battery cell charge and discharge jigs described above are assembled, in one or more jigs, the socket fastening unit satisfies two or three of the above conditions. In some cases, in one or more other jigs, the socket fastening unit satisfies one of the above conditions.

In a specific example, in a jig for charging and discharging a battery cell according to the present invention, at least one electrical connection pin is formed at the one end of the socket fastening unit, and at least one groove for accommodating the electrical connection pin is formed at the other end of the socket fastening unit. In the present invention, the specific shape of the socket formed in the socket fastening unit is not particularly limited. For example, various schemes such as a male and female fastening scheme, a scheme of picking up a protrusion with tongs, a screw fastening scheme, a magnet fastening scheme, and a hinge fixing scheme may be used as the shape of the socket. For example, at one end of the socket fastening unit, a connection pin is protruded to be inserted into a jig terminal to thereby be electrically connected, and at the other end of the socket fastening unit, a plurality of connection sockets are formed, and each of the connection sockets has a groove for accommodating a connection pin for electric connection. In some cases, a fastening by a screw may be added in a state that the connection pin has been inserted.

In another embodiment, the battery cell charge and discharge jig fixes a battery cell using a fixing unit, and the fixing unit presses both surfaces of the battery cell using a pressing plate. In this case, the first and second terminal portions may be electrically connected to first and second electrode leads, respectively, in a state that the first and second electrode leads of the battery cell are fixed.

The jig for charging and discharging a battery cell according to the present invention may selectively fix only the electrode lead portion without a separate pressing plate. However, when applied to the activation process of the battery cell, it is advantageous to press both surfaces of the battery cell using a pressing plate in order to smoothly discharge gas trapped in the battery cell. The pressing plate includes first and second pressing plates facing each other, and the battery cell may be charged/discharged and pressed in a state that the battery cell is interposed between the first and second pressing plates.

In another example, the fixing unit presses two surfaces of the battery cell through a pressing plate, and further includes at least one of: a pressure sensor which measures pressure of the battery cell; and a temperature sensor which measures a temperature of the battery cell. According to a battery cell charge and discharge jig of the present invention, it is possible to determine whether a battery cell is defective by examining the swelling degree of the battery charging and discharging system using a pressure sensor and determine a heated degree of the battery cell using a temperature sensor.

Further, the present invention provides a system for charging and discharging a battery cell, which includes the above-described jig for charging and discharging a battery cell. In one example, the system includes: a number of n jigs for charging and discharging a battery cell; and a power supply unit. Herein, the n is a positive integer equal to or greater than 2. The number n of the battery cell charge and discharge jigs corresponds to the number of battery cells to be charged and discharged at a time. For example, the number of the battery cell charge and discharge jig is in the range of 2 to 100, 10 to 80, or 20 to 60. For example, one battery module is formed by combining 48 battery cells, and when the battery cells accommodated in the battery module are charged and discharged at a time, 48 battery cell charge and discharge jigs are applied to charge and discharge the battery cells.

Further, when the number of n charge and discharge battery cell jigs charge and discharge battery cells in a state that has accommodated the battery cells, respectively, the charge and discharge battery cell jigs may be arranged in series and/or in parallel in order to allow the voltage of the power applied from the power supply unit to correspond to the rated voltage of the battery cell.

In a specific example, the power supply unit is a single power source, and the number of n jigs are electrically connected to each other in at least one of a serial connection scheme and a parallel connection scheme in a state that has accommodated battery cells. For example, battery cells accommodated in 48 battery cell jigs may be simultaneously charged and discharged using a single power supply unit.

When a plurality of battery cells are simultaneously charged and discharged, the power connection line, which is fastened to the connection socket formed at the socket fastening unit of each battery cell jig, may be switched to satisfy the rated voltage condition of the battery cell. For example, when the rated voltage of the battery cell is small, it is possible to adjust the connection relation to correspond to the applied voltage of the power supply unit by increasing the number of battery cells connected in series.

### DETAILED DESCRIPTION OF THE PREFERRED EMBODIMENTS

Although preferred examples of the present invention will be described with reference to drawings, it can be understood that those skilled in the art can make various modifications and changes to the present invention without departing from the spirit and scope of the invention as set forth in the claims below.

### First Embodiment

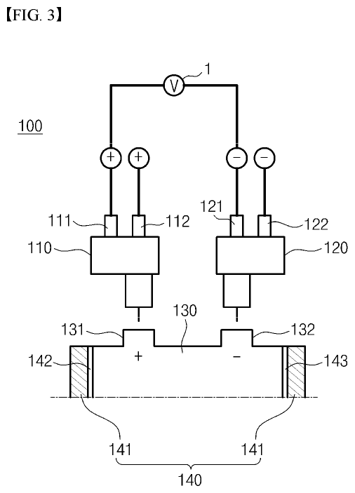

FIG. 3 is a schematic diagram showing a structure of fastening a power terminal which connects an external power source to a socket fastening unit in a battery cell charge and discharge jig according to one embodiment of the present invention. Referring to FIG. 3, the jig 100 for charging and discharging a battery cell according to the present invention includes a battery cell 130 accommodated in a fixing unit, and first and second terminal portions 131 and 132 which are electrically connected to first and second electrode leads. Further, the first and second socket fastening units 110 and 120 are fastened to the first and second terminal portions 131 and 132, respectively. 2 connection sockets are formed in the first socket fastening unit 120, and first and second connection terminals 111 and 112 are fastened to each connection socket. The first connection terminal 111 is electrically connected to (+) terminal of the power supply unit, and the second connection terminal 112 is electrically connected to another jig in parallel. Further, 2 connection sockets are formed in the second socket fastening unit 120, and third and fourth connection terminals 121 and 122 are fastened to each connection socket. The third connection terminal 121 is electrically connected to (−) terminal of the power supply unit, and the fourth connection terminal 122 is electrically connected to another jig in parallel.

Additionally, the battery cell 130 is fixed at the fixing unit 140. The fixing unit 140 presses both surfaces of the battery cell 130 using a pressing plate 141. Also the fixing unit 140 further includes at least one of a pressure sensor 142 which measures pressure of the battery cell 130 and a temperature sensor 143 which measures a temperature of the battery cell 130. According to present jig 100, it is possible to determine whether a battery cell 130 is defective by examining the swelling degree of the battery charging and discharging system using a pressure sensor 142 and determine a heated degree of the battery cell 130 using a temperature sensor 143.

### Second Embodiment

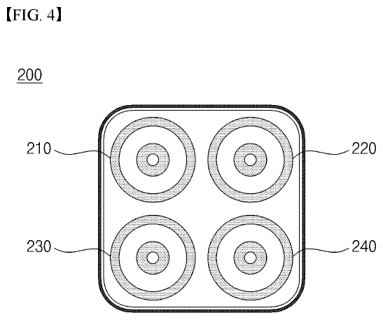

FIG. 4 is a plan view showing a socket fastening unit in a battery cell charge and discharge jig according to one embodiment of the present invention. Referring to FIG. 4, in a jig for charging and discharging a battery cell according to the present invention, connection sockets 210, 220, 230 and 240 are formed at the other end of a socket fastening unit 200. 2 connection sockets 210 and 220 at the upper end of the socket fastening unit 200 are sockets for serial connection, and 2 connection sockets 230 and 240 at the lower end of the socket fastening unit 200 are sockets for parallel connection. One of the sockets for serial connection is fastened to the power supply unit, and another of the sockets for serial connection is electrically connected to another jig in series. Further, the socket for parallel connection may be electrically connected to another jig in parallel. Each of the connection sockets 210, 220, 230 and 240 formed at the socket fastening unit has a groove for fastening an external terminal of an electric connection pin type.

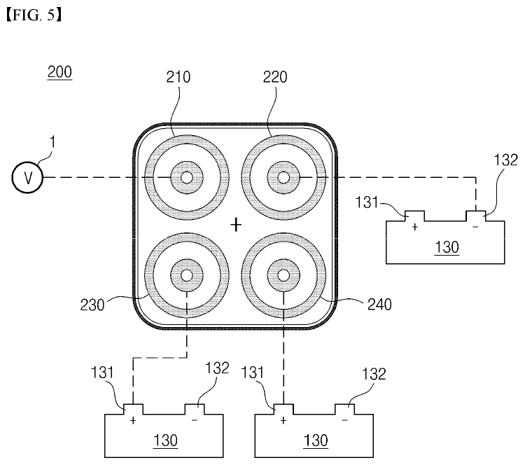

Referring to FIG. 5, the socket for serial connection 210 and 220 is electrically connected to another battery cell 130 in series and electrically connected to a power supply unit 1. And the socket for parallel connection 230 and 240 is electrically connected to another battery cell 130 in parallel. It may be changed according to the standard of the battery cell 130, but for example, when the voltage applied to the power supply unit 1 is the same as the charge and discharge voltage of the battery cell 130, direct electric connection is made with the power supply unit 1 through the socket for serial connection 220.

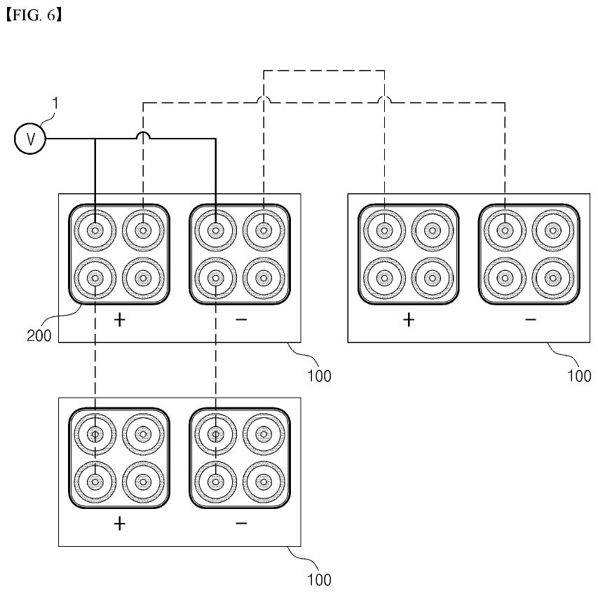

Referring to FIG. 6, the electric serial connection 220 is made with the terminal portion of another adjacent jig 100 so that the same voltage may be applied to the battery cell 130 accommodated in an adjacent jig 100. When the voltage applied to the power supply unit 1 is different from the charge and discharge voltage of the battery cell 130, electric connection is made with the power supply unit 1 through the socket for parallel connection 230 and 240, and electric parallel connection 230 and 240 is made with the terminal portion of another adjacent jig 100. Through this, the charge and discharge voltage required in the battery cell 130 is made to fit the voltage applied from the power supply unit 1.

In the above, the present invention has been described in detail with reference to the drawings, but the technical scope of the present invention will not be limited to the contents described in the detailed description of the specification, but should be determined by the claims.

### DESCRIPTION OF REFERENCE NUMERALS

1: power supply
20 10, 100: jig for charging and discharging battery cell
11: first power terminal
12: second power terminal
20, 130: battery cell
21, 131: first terminal portion
22, 132: second terminal portion
110: first socket fastening unit
120: second socket fastening unit
111: first connection terminal
112: second connection terminal
121: third connection terminal
122: fourth connection terminal
140: fixing unit
141: pressing plate
142: pressure sensor
143: temperature sensor
200: socket fastening unit
210, 220, 230, 240: connection socket

1. A jig for charging and discharging a battery cell, the jig comprising:
a fixing unit to fix a battery cell;
first and second terminal portions which are electrically connectable to first and second electrode leads of the fixed battery cell, respectively; and
a socket fastening unit having a first end fastened to the first terminal portion or the second terminal portion, and a second end having two or more connection sockets to be electrically connected to an external side.

2. The jig of claim 1, wherein at least one of the two or more connection sockets is a socket for serial connection and at least one other of the two or more connection sockets is a socket for parallel connection.

3. The jig of claim 2, wherein the at least one of the two or more connection sockets for serial connection is electrically connectable to another battery cell in series or is electrically connected to a power supply unit, and
wherein the at least one other of the two or more connection sockets for parallel connection is electrically connectable to another battery cell in parallel.

4. The jig of claim 2, wherein the socket fastening unit includes a number of p sockets for serial connection and a number of q sockets for parallel connection as the two or more connection sockets,
wherein p is a positive integer between 1 and 20, and
wherein q is a positive integer between 1 and 20.

5. The jig of claim 1, wherein the first end of the socket fastening unit is fastenable to the first terminal portion of the battery cell fixed at the fixing unit, and
wherein the two or more connection sockets at the second end of the socket fastening unit include one or more sockets for serial connection and one or more sockets for parallel connection, which satisfy at least one of:
a condition that at least one of the sockets for serial connection is electrically connected to a power supply unit;
a condition that at least one of the sockets for serial connection is electrically connected to a second terminal portion of another battery cell adjacent to the battery cell; and
a condition that at least one of the sockets for parallel connection is electrically connected to a first terminal portion of another battery cell adjacent to the battery cell.

6. The jig of claim 1, wherein at least one electrical connection pin is provided at the first end of the socket fastening unit, and
wherein at least one groove for accommodating the electrical connection pin is provided at the second end of the socket fastening unit.

7. The jig of claim 1, wherein the fixing unit is configured to press two surfaces of the battery cell through a pressing plate, and
wherein the first and second terminal portions are electrically connectable to the first and second electrode leads, respectively, in a state that the first and second electrode leads of the battery cell are fixed.

8. The jig of claim 1, wherein the fixing unit is configured to press two surfaces of the battery cell through a pressing plate, and further includes at least one of:
a pressure sensor to measure pressure of the battery cell; or
a temperature sensor to measure a temperature of the battery cell.

9. A system for charging and discharging a battery cell, the system comprising:
a number of n jigs for charging and discharging a battery cell according to claim 1; and
a power supply unit,
wherein the n is a positive integer equal to or greater than 2.

10. The system of claim 9, wherein the number of n jigs are arranged in series or in parallel in a state that has accommodated battery cells.

11. The system of claim 9, wherein the power supply unit is a single power source, and
wherein the number of n jigs are electrically connected to each other in at least one of a serial connection scheme and a parallel connection scheme in a state that has accommodated battery cells.

12. The system of claim 11, wherein a power connection line, which is fastened to one of the one or more connection sockets of the socket fastening unit of each jig, is switched to satisfy a rated voltage condition of the battery cell.
